(19) United States
(12) Patent Application Publication
(10) Pub. No.: US 2011/0090185 A1
(43) Pub. Date: Apr. 21, 2011

(54) INFORMATION PROCESSING APPARATUS AND IMAGE DISPLAY METHOD

(75) Inventor: Shunichiro Watanabe, Fuchu-shi (JP)

(73) Assignee: CANON KABUSHIKI KAISHA, Tokyo (JP)

(21) Appl. No.: 12/905,964

(22) Filed: Oct. 15, 2010

(30) Foreign Application Priority Data
Oct. 19, 2009 (JP) 2009-240513

(51) Int. Cl. G09G 5/00

(52) U.S. Cl. 345/204

(57) ABSTRACT

An information processing apparatus having a plurality of displays may include a reception unit, a determination unit, and a display unit. The reception unit may receive, from a display control apparatus, display image information about a plurality of images that are displayed on a display of the display control apparatus. The determination unit may determine, based on the display image information received by the reception unit and configuration information about the plurality of displays, which of the plurality of displays is to display the plurality of images indicated by the display image information. The display unit may display the plurality of images on the plurality of displays based on a determination by the determination unit.

### BACKGROUND OF THE INVENTION

1. Field of the Invention

The present invention relates to an information processing apparatus and an image display method.

2. Description of the Related Art

In a presentation system, an album can be created using photographed photos together with a customer in real time, and thus, the album specialized for the customer can be generated. Therefore, a level of customer satisfaction can be improved. In addition, the presentation system aims to encourage a customer's willingness to buy more products by effectively performing presentation for the customer.

In the presentation system, an operator display control apparatus and a customer photographed-image display apparatus are communicatably connected to each other via a network.

The operator display control apparatus is an apparatus used by an operator of a photo studio to select images or execute a layout of commercial materials and focuses on enabling the operator to smoothly execute operations.

The customer photographed-image display apparatus is an apparatus for displaying the photos or the commercial materials selected in the operator display control apparatus and focuses on performing an effective representation for the customer. In an electronic conference system discussed in Japanese Patent Application Laid-Open No. 2007-4611, information displayed on a display by a presenter and information which is not displayed on the display by the presenter are simultaneously displayed on a screen of an own computer. In the related art, there is a problem that since an operator always needs to pay attention to both an operation screen of the operator display control apparatus and a display screen of the customer photographed-image display apparatus, a large burden is put on the operator.

### SUMMARY OF THE INVENTION

The present invention is directed to a technique in which an operator can effectively display an image for a customer by operating a display control apparatus for the operator without considering a configuration of an information processing apparatus for a customer.

According to an aspect of the present invention, an information processing apparatus having a plurality of displays may include a reception unit, a determination unit, and a display unit. The reception unit may receive, from a display control apparatus, display image information about a plurality of images that are displayed on a display of the display control apparatus. The determination unit may determine, based on the display image information received by the reception unit and configuration information about the plurality of displays, which of the plurality of displays is to display the plurality of images indicated by the display image information. The display unit may display the plurality of images on the plurality of displays based on a determination by the determination unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a system configuration of a presentation system.

FIG. 2 illustrates an example of a hardware configuration of an operator display control apparatus.

FIG. 3 illustrates an example of a hardware configuration of a customer photographed-image display apparatus according to a first exemplary embodiment of the present invention.

FIGS. 4A and 4B illustrate examples of screens displayed by the operator display control apparatus.

FIGS. 5A to 5C illustrate examples of screens displayed by the customer photographed-image display apparatus according to the first exemplary embodiment.

FIGS. 6A and 6B illustrate examples of display image information transmitted from the operator display control apparatus to the customer display control apparatus.

FIGS. 7A and 7B are flowcharts illustrating an example of a synchronization process regarding image display between the operator display control apparatus and the customer display control apparatus according to the first exemplary embodiment.

FIG. 8 illustrates an example of a hardware configuration of a customer photographed-image display apparatus according to a second exemplary embodiment of the present invention.

FIGS. 9A to 9D illustrate examples of screens displayed by the customer photographed-image display apparatus according to the second exemplary embodiment.

FIGS. 10A and 10B are flowcharts illustrating an example of a synchronization process regarding image display between the operator display control apparatus and the customer display control apparatus according to the second exemplary embodiment.

### DESCRIPTION OF THE EMBODIMENTS

Various exemplary embodiments, features, and aspects of the invention will be described in detail below with reference to the drawings.

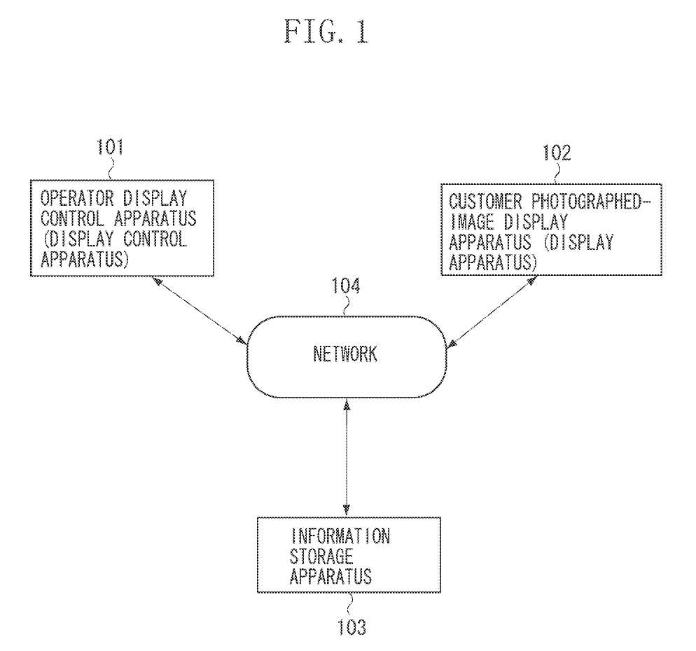

A first exemplary embodiment of the present invention will be described below with reference to FIGS. 1 to 7. FIG. 1 illustrates an example of a system configuration of a presentation system. As illustrated in FIG. 1, the presentation system includes an operator display control apparatus (display control apparatus) 101, a customer photographed-image display apparatus (display apparatus) 102, and an information storage apparatus (storage apparatus) 103. The display control apparatus 101, the display apparatus 102, and the storage apparatus 103 are communicably connected to each other via a network 104. The display control apparatus 101 transmits display image information to the display apparatus 102 via the network 104, and stores and acquires the information in and from the storage apparatus 103. The display apparatus 102 receives the display image information from the display control apparatus 101 via the network 104 and acquires the information from the storage apparatus 103. The storage apparatus 103 stores data to be used by the display control apparatus 101 and the display apparatus 102.

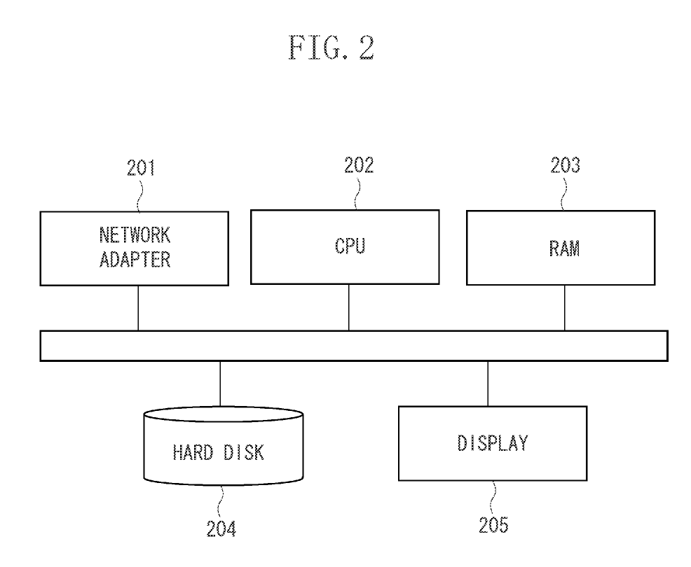

FIG. 2 illustrates an example of a hardware configuration of the display control apparatus 101. A network adapter 201 controls communication between the display control apparatus 101 and the display apparatus 102 via the network 104.

A central processing unit (CPU) 202 controls the entire display control apparatus 101. A random access memory (RAM) 203 temporarily records a program, communication data, or the like. A hard disk 204 permanently records a program, data, or the like. A display 205 displays information. The CPU 202 reads a program stored in the hard disk 204 to the RAM 203 and executes the program, and thus functions of the operator display control apparatus 101 described below and processes illustrated in a flowchart executed by the operator display control apparatus 101 can be realized.

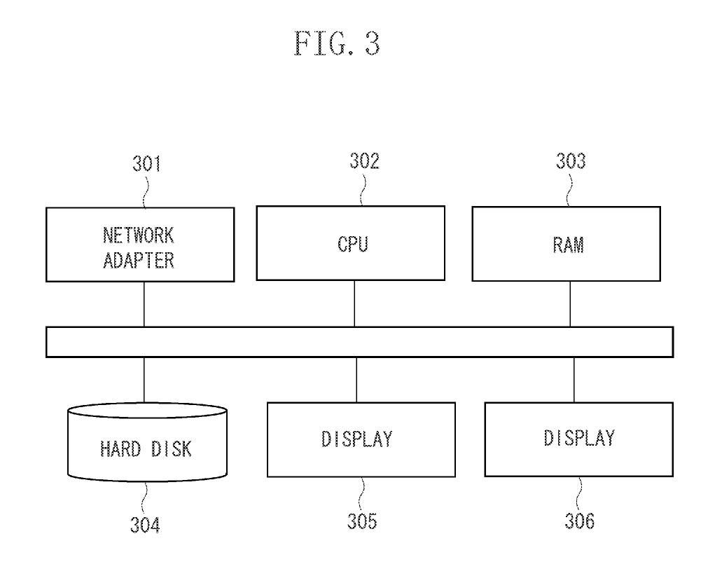

FIG. 3 illustrates an example of a hardware configuration of the display apparatus 102 according to the first exemplary embodiment. A network adapter 301 controls communication between the display apparatus 102 and the display control apparatus 101 via the network 104. A CPU 302 controls the entire display apparatus 102. A RAM 303 temporarily records a program, communication data, or the like. A hard disk 304 permanently records a program controlling the display apparatus 102 or data. A display (first display) 305 and a display (second display) 306 display information.

The CPU 302 reads a program stored in the hard disk 304 to the RAM 303 and executes the program, and thus functions of the display apparatus 102 described below and the processes illustrated in a flowchart executed by the display apparatus 102 can be realized.

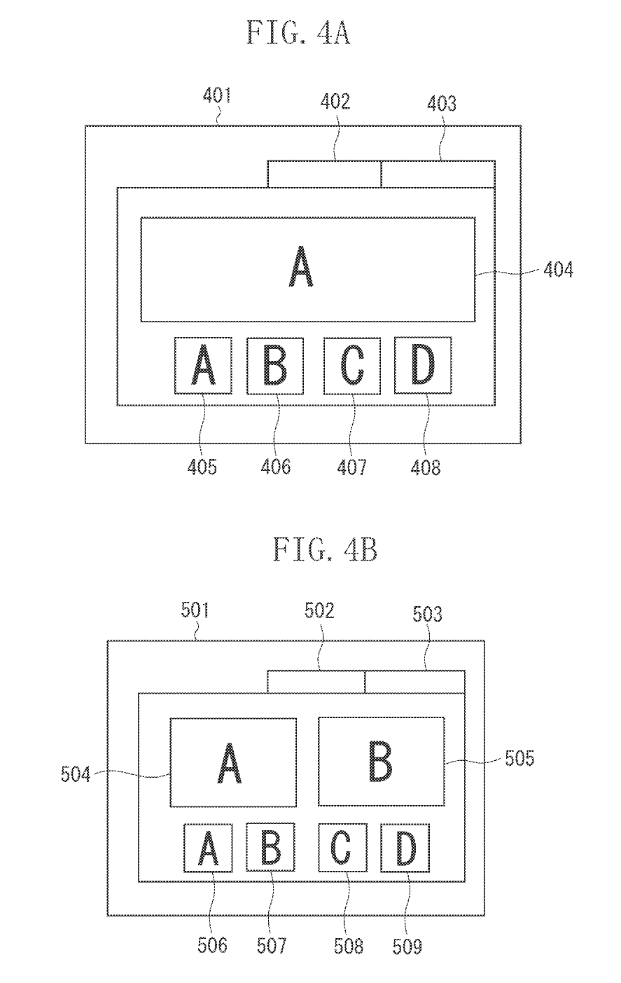

FIGS. 4A and 4B illustrate examples of screens displayed by the display control apparatus 101. In FIG. 4A, a screen configured to display details of one image among a plurality of images is illustrated. The details of a selected image are displayed by displaying the selected image larger than other selectable images.

A screen 401 includes the entire structure of a first screen. A tab 402 is a tab for changing a display screen to the first screen. A tab 403 is a tab for changing a display screen to a second screen. In an area 404, details of a selected image are displayed. Images 405, 406, 407, and 408 are images which can be displayed in the area 404. In the example of FIG. 4A, the image 405 is displayed in the area 404.

In FIG. 4B, a screen in which two images among the plurality of images are displayed in detail to compare to each other is illustrated. A screen 501 includes the entire structure of the second screen. A tab 502 is a tab for changing a display screen to the first screen. A tab 503 is a tab for changing a display screen to the second screen. In an area 504, details of the selected image are displayed. In an area 505, details of the selected image are displayed similar to the area 504. Images 506, 507, 508, and 509 are images which can be displayed in the areas 504 and 505. The displayed images 506, 507, 508, and 509 are the same as the images 405, 406, 407, and 408 respectively. In the example of FIG. 4B, the image 506 is displayed in the area 504 and the image 507 is displayed in the area 505.

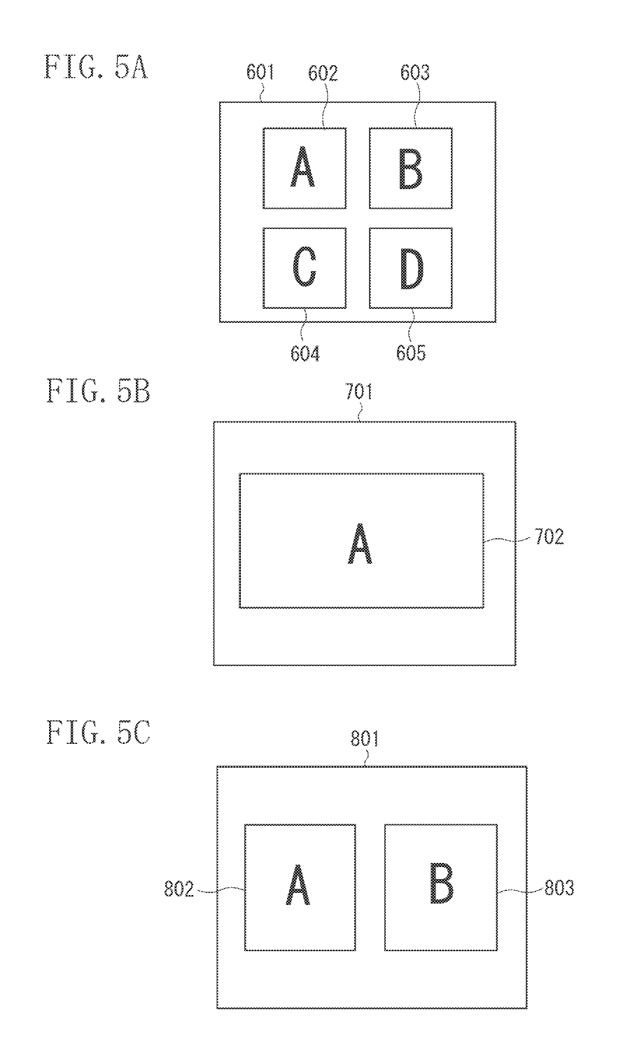

FIGS. 5A to 5C illustrate examples of screens to be displayed on the display apparatus 102 according to the first exemplary embodiment. A screen 601 in FIG. 5A includes the entire structure of a third screen. Images 602, 603, 604, and 605 are thumbnails (reduced images) of images. The same images as the images 405, 406, 407, and 408 on the first screen and the same images as the images 506, 507, 508, and 509 on the second screen are displayed respectively.

A screen 701 in FIG. 5B includes the entire structure of a fourth screen. In an area 702, an enlarged image is displayed. In the example of FIG. 5B, an image A 602 is displayed in the area 702.

A screen 801 in FIG. 5C includes the entire structure of a fifth screen. In an area 802, an enlarged image is displayed. In the example of FIG. 5C, the image A 602 is displayed in the area 802. In an area 803, an enlarged image is displayed. In the example of FIG. 5C, an image B 603 is displayed in the area 803.

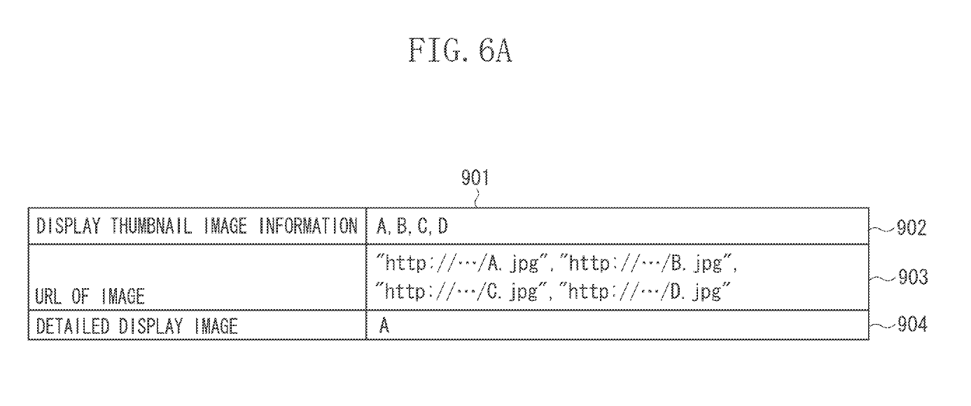

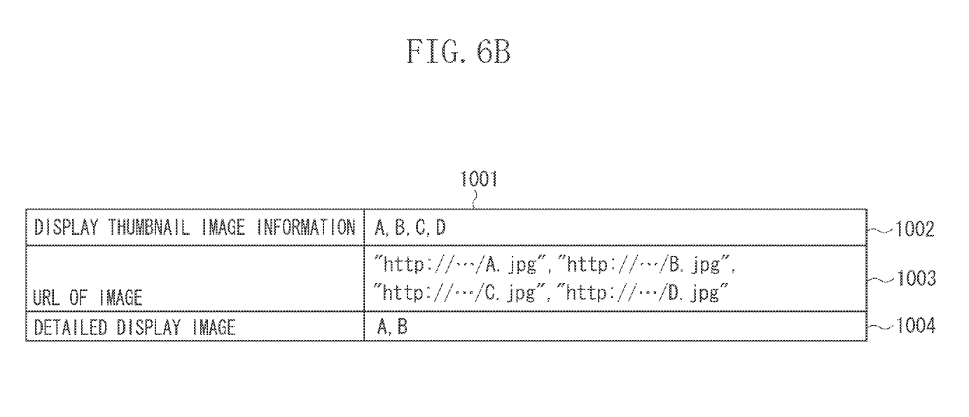

FIGS. 6A and 6B illustrate examples of display image information transmitted from the display control apparatus 101 to the display apparatus 102. A list 901 includes the information to be transmitted. Information 902 is display thumbnail image information. In the example of FIG. 6A, identifications (IDs) of all images to be displayed are transmitted in a comma separated format. A uniform resource locator (URL) 903 is the URL of an image. In the example of FIG. 6A, the URLs of all images to be displayed are transmitted in a comma separated format. An ID 904 is the ID of an image to be displayed in detail. In the example of 6A, A is transmitted as the ID of the image to be displayed in detail.

A list 1001 includes the information to be transmitted. Information 1002 is display thumbnail image information. In the example of FIG. 6B, IDs of all images to be displayed are transmitted in a comma separated format. A URL 1003 is the URL of an image. In the example of FIG. 6B, the URLs of all images to be displayed are transmitted in a comma separated format. IDs 1004 are the IDs of images to be displayed in detail. In the example of 6B, A and B are transmitted as the IDs of the images to be displayed in detail.

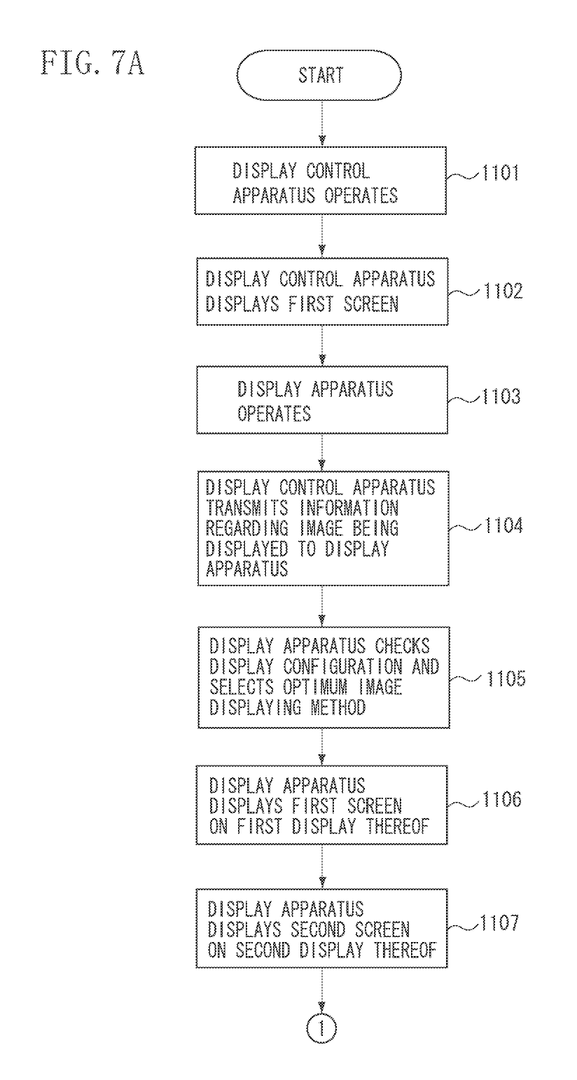

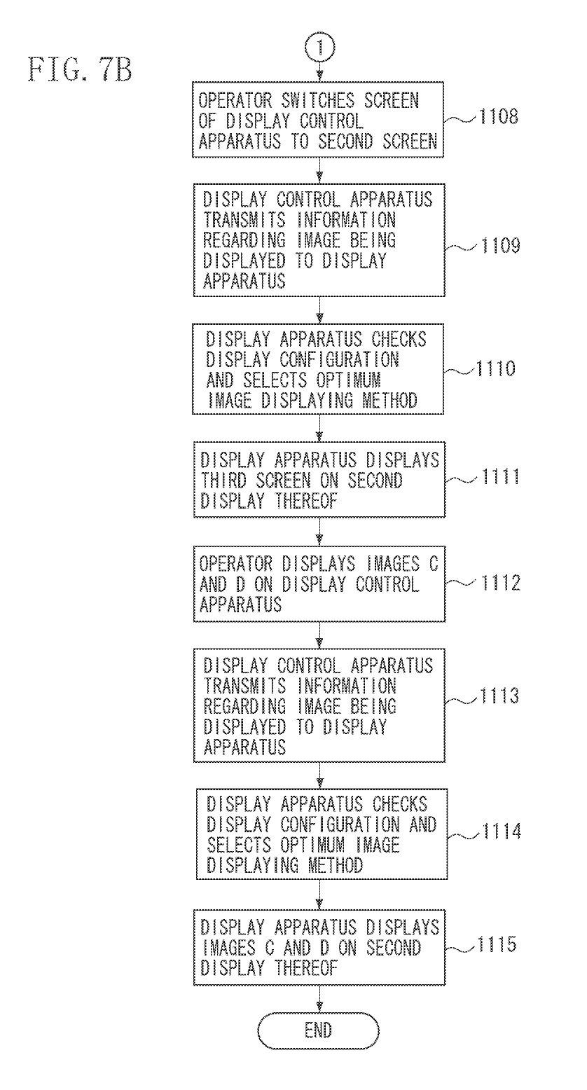

FIGS. 7A and 7B are flowcharts illustrating an example of a synchronization process regarding image display between the display control apparatus 101 and the customer display apparatus 102 according to the first exemplary embodiment. In step S1101, the display control apparatus 101 starts an operation in response to an operation of an operator. In step S1102, the display control apparatus 101 displays a first screen on the display 205 of the display control apparatus 101. For example, the display control apparatus 101 displays the screen 401 on the display 205.

In step S1103, likewise, the display apparatus 102 starts an operation in response to an operation of the operator. In step S1104, the display control apparatus 101 transmits information (display image information) regarding an image which is displayed on the screen of the display 205 to the display apparatus 102. For example, the display control apparatus 101 transmits the information 901 to the display apparatus 102.

In step S1105, after receiving the information 901, the display apparatus 102 selects (or determines) an optimum image display method based on the received information and a display configuration of the display apparatus 102. In the example of the present exemplary embodiment, the display apparatus 102 includes two displays, that is, the displays 305 and 306. The display apparatus 102 comprehends a need to display a plurality of thumbnail images and detailed display images from the received information.

Accordingly, the display apparatus 102 determines that an optimum image display configuration is to display the thumbnail images on one screen (the display 305) and to display the detailed display images on the other screen (the display 306). Configuration information is assumed to be stored in, for example, a hard disk of the display apparatus 102. Based on the received information 901, the display apparatus 102 displays the images on the screens according to the display method selected in step S1105. More specifically, in step S1106, the display apparatus 102 displays the third screen 601 on the display 305, and then in step S1107, the display apparatus 102 displays the fourth screen 701 on the display 306. The display apparatus 102 acquires the images from the storage apparatus 103 based on the URIs of the images included in the received information and displays the images.

After executing certain operations, the operator compares the images to each other and asks for a customer to select an image. In step S1108, the display control apparatus 101 switches the screen 401 to the screen 501 in response to an operation to select the tab 403 by the operator. In step S1109, the display control apparatus 101 transmits the information (the display image information) regarding the image which is displayed on the screen of the display 205 to the display apparatus 102. For example, the display control apparatus 101 transmits the information 1001 to the display apparatus 102. In step S1110, after receiving the information 1001, the display apparatus 102 selects an optimum image display method based on the received information and the configuration of the display apparatus 102.

In the example of the present exemplary embodiment, the display apparatus 102 includes two displays, that is, the displays 305 and 306. The display apparatus 102 comprehends the need to display the plurality of thumbnail images and the detailed display images from the received information. Accordingly, the display apparatus 102 determines that the optimum image display configuration is to display the thumbnail images on one screen (the display 305) and to display the detailed display images on the other screen (the display 306). Since the display apparatus 102 has already displayed the third screen 601 on the display 305, in step S1111, the display apparatus 102 does not change the screen on the display 305 and displays the fifth screen 801 on the display 306.

When the customer requests the operator to compare other images to each other, the operator operates the screen 501 of the display control apparatus 101 to display the details of the other images. In the present exemplary embodiment, it is assumed that the operator operates to display the details of the images C 508 and D 509. In step S1112, the display control apparatus 101 displays the details of the images C 508 and D 509 on the screen of the display 205 based on the operation by the operator. In step S1113, the display control apparatus 101 transmits the information (the display image information) regarding the images which are displayed on the screen of the display 205 to the display apparatus 102. For example, the display control apparatus 101 transmits the information regarding the detailed display images C and D replacing the detailed display images A and B of the information 1001 to the display apparatus 102.

In step S1114, after receiving the information, the display apparatus 102 selects the optimum image display method based on the received information and the display configuration of the display apparatus 102. In the example of the present exemplary embodiment, the display apparatus 102 includes two displays, that is, the displays 305 and 306. The display apparatus 102 comprehends the need to display the plurality of thumbnail images and the detailed display images from the received information. Accordingly, the display apparatus 102 determines that the optimum image display configuration is to display the thumbnail images on one screen (the display 305) and to display the detailed display images on the other screen (the display 306).

Since the display apparatus 102 has already displayed the third screen 601 and the fifth screen 801 on the displays 305 and 306, respectively, the display apparatus 102 does not switch the screen and changes only the detailed image to be displayed. More specifically, in step S1115, the display apparatus 102 displays the detailed information about the images C 508 and D 509 on the fifth screen 801.

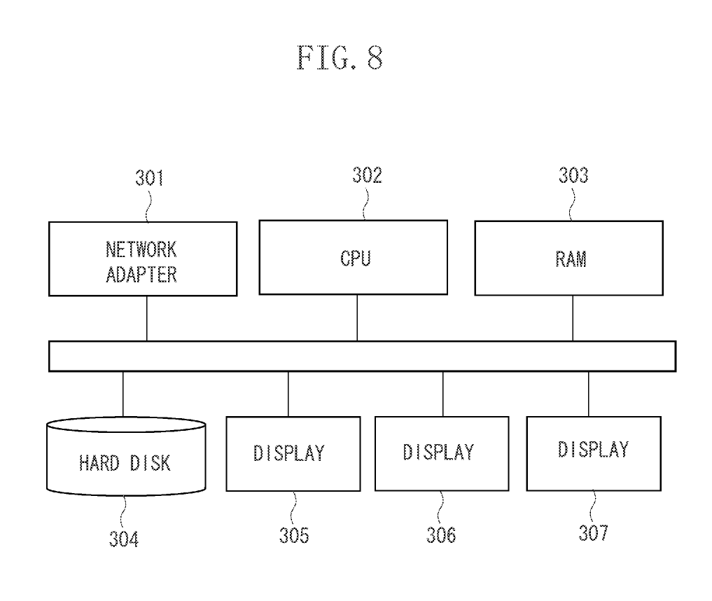

A second exemplary embodiment of the present invention will be described below with reference to FIGS. 8 to 10. In the second exemplary embodiment, the configuration of the display control apparatus 101 is similar to that in the first exemplary embodiment, and it will be described a case in which three screens are used in the display of the display apparatus 102 instead of two screens. FIG. 8 illustrates an example of a hardware configuration of the display apparatus according to the second exemplary embodiment.

As illustrated in FIG. 8, the hardware configuration of the display apparatus 102 according to the present exemplary embodiment is different from the hardware configuration of the display apparatus 102 according to the first exemplary embodiment in that a display (third display) 307 is further included.

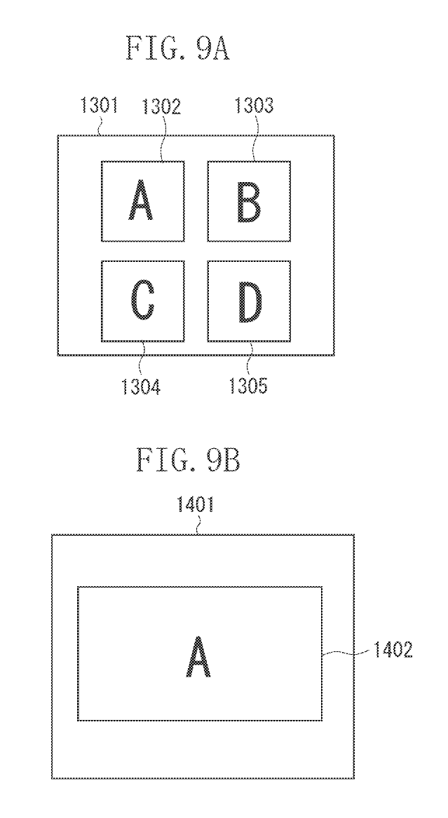

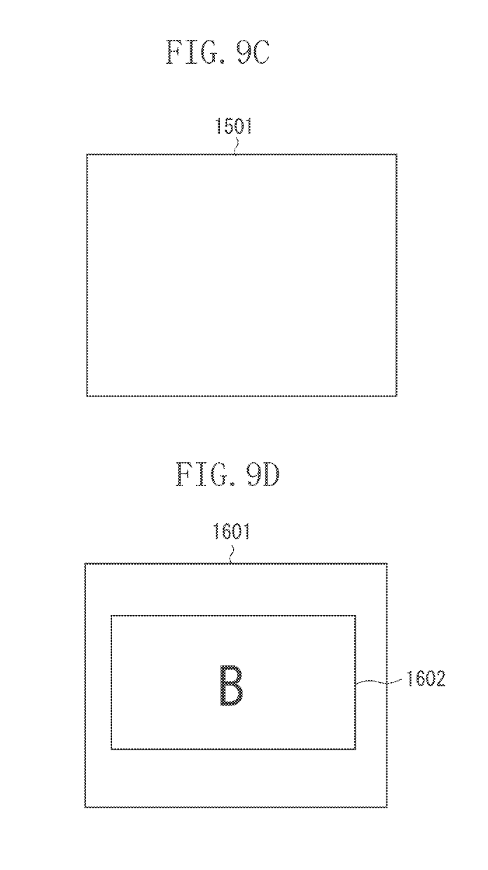

FIGS. 9A to 9D illustrate examples of screens displayed by the display apparatus according to the second exemplary embodiment. A screen 1301 in FIG. 9A includes the entire structure of a sixth screen. Images 1302, 1303, 1304, and 1305 are thumbnail images. These images are the same as the images 405, 406, 407, and 408 on the first screen or the images 506, 507, 508, and 509 on the second screen, respectively. A screen 1401 in FIG. 9B includes the entire structure of a seventh screen. In an area 1402, an enlarged image is displayed. In the example of FIG. 9B, an image A 1302 is displayed in the area 1402. A screen 1501 in FIG. 9C includes the entire structure of an eighth screen. The eighth screen has no function and serves as a standby screen. A screen 1601 in FIG. 9D includes the entire structure of a ninth screen. In an area 1602, an enlarged image is displayed. In the example of FIG. 9D, an image B 1303 is displayed in the area 1602.

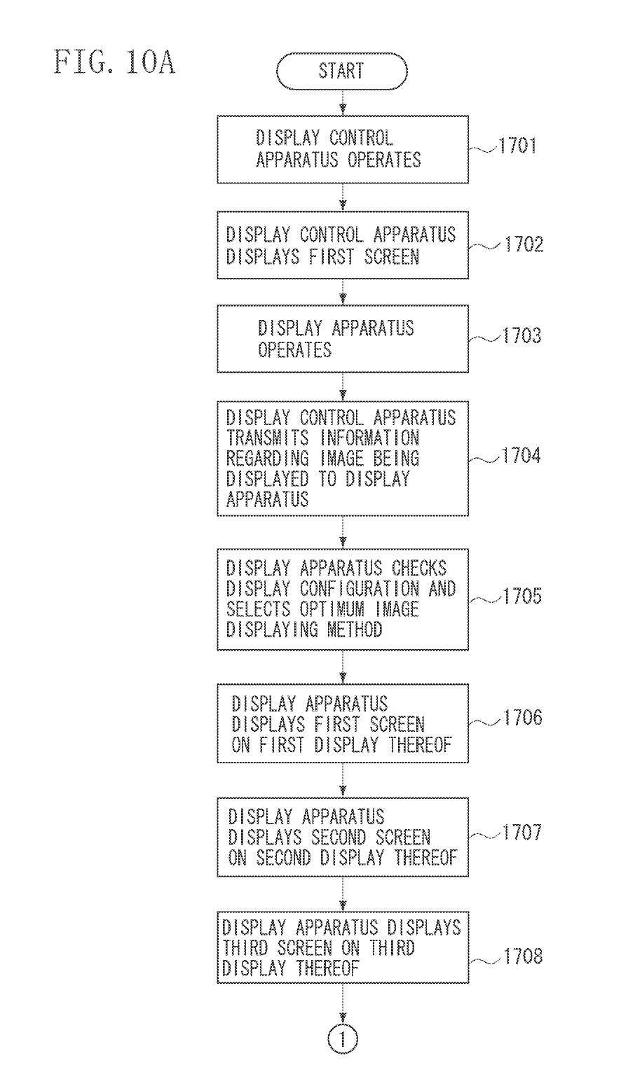

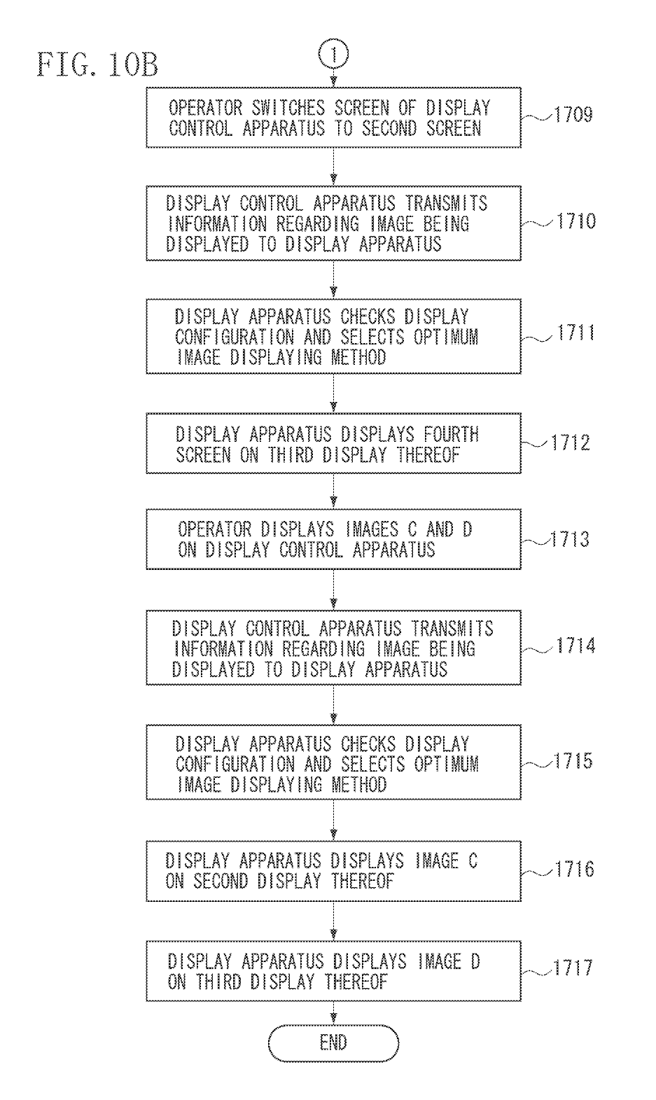

FIGS. 10A and 10B are flowcharts illustrating an example of a synchronization process regarding image display between the display control apparatus 101 and the customer display apparatus 102 according to the second exemplary embodiment. The operations of the operator and the operations of the display control apparatus 101 are the same as those according to the first exemplary embodiment. The operations of the display apparatus 102 are different from those according to the first exemplary embodiment.

Since processes in steps 51701 to 51704 are the same as the processes of step S1101 to 51104 according to the first exemplary embodiment respectively, the descriptions thereof are omitted. In step S1705, after receiving the information 901, the display apparatus 102 selects the optimum image display method based on the received information and the display configuration of the display apparatus 102.

In the present exemplary embodiment, the display apparatus 102 includes three displays, that is, the displays 305, 306, and 307. The display apparatus 102 comprehends the need to display the plurality of thumbnail images and detailed display images from the received information. Accordingly, the display apparatus 102 determines that the optimum image display configuration is to display the thumbnail images on the display 305 and to display the detailed display images on the other screens.

Based on the received information 901, the display apparatus 102 displays the images on the screens according to the method selected in step S1705. More specifically, in step S1706, the display apparatus 102 displays the sixth screen 1301 on the display 305, and then in step S1707, the display apparatus 102 displays the seventh screen 1401 on the display 306. Further, in step S1708, the display apparatus 102 displays the eighth screen 1501 on the display 307.

Since processes in steps 51709 and 51710 are the same as those in steps 51108 and 1109 according to the first exemplary embodiment respectively, the descriptions thereof are omitted. In step S1711, after receiving the information 1001, the display apparatus 102 selects the optimum image display method based on the received information and the display configuration of the display apparatus 102.

In the example of the present exemplary embodiment, the display apparatus 102 includes three displays, that is, the displays 305, 306, and 307. The display apparatus 102 comprehends the need to display the plurality of thumbnail images and the detailed display images from the received information. Accordingly, the display apparatus 102 determines that the optimum image display configuration is to display a list of the images on the display 305 and to display one detailed display image on each of the other screens.

Since the display apparatus 102 has already displayed the sixth screen 1301 on the display 305, the display apparatus 102 does not switch the screen of the display 305. In addition, since the display apparatus 102 has already displayed the seventh screen 1401 on the display 306, the display apparatus 102 does not switch the screen of the display 306. In step S1702, the display apparatus 102 thus displays the ninth screen 1601 on the remaining display 307.

Since processes in steps 51713 and 51714 are the same as those in steps 51112 and 1113 according to the first exemplary embodiment respectively, the descriptions thereof are omitted. In step S1715, after receiving information transmitted from the display control apparatus 101, the display apparatus 102 selects the optimum image display method based on the received information and the display configuration of the display apparatus 102.

In the example of the present exemplary embodiment, the display apparatus 102 includes three displays, that is, the displays 305, 306, and 307. The display apparatus 102 comprehends the need to display the plurality of thumbnail images and the detailed display images from the received information. Accordingly, the display apparatus 102 determines that the optimum image display configuration is to display the thumbnail images on one display (the display 305) and to display one detailed display image on each of the other screens.

The display apparatus 102 has already displayed the sixth screen 1301 on the display 305. Further, the display apparatus 102 has already displayed the seventh screen 1401 on the display 306. Since the display apparatus 102 has displayed the ninth screen 1601 on the display 307, the display apparatus 102 does not switch the screen and switches only the detailed image to be displayed. In step S1716, the display apparatus 102 displays the detailed information about the image C 508 on the seventh screen 1401. Then in step S1717, the display apparatus 102 displays the detailed information about the image D 509 on the ninth screen 1601.

According to the present invention, as described above, an operator can effectively display images for a customer by operating the operator display control apparatus without considering the configuration of the customer apparatus (information processing apparatus).

Objects of the above-described exemplary embodiments can also be achieved by reading and executing program codes of software for realizing the functions of the above-described exemplary embodiments by a central processing unit (CPU or a micro processing unit (MPU)) of the apparatus. The functions of the above-described exemplary embodiments can also be realized by executing a part or all of the actual processes by an operating system (OS) based on an instruction of the read program codes. When the above-described exemplary embodiments are applied to the storage medium, program codes corresponding to the above-described flowcharts are stored in the storage medium (computer readable storage medium). In an example, a computer-readable medium may have a program stored thereon that causes a computer or an information processing apparatus having a plurality of displays to perform a method described herein.

According to the above-described exemplary embodiments, an operator can effectively display images for a customer by operating the display control apparatus 101 without considering the configuration of the display apparatus 102. Further, according to the above-described exemplary embodiments, the system configuration of the presentation system may be changed dynamically according to a request of a customer to perform optimum presentation. Furthermore, according to the above-described exemplary embodiments, the images can be effectively displayed even when a customer is located in a physically distant place.

A display control apparatus described in claims corresponds to, for example, the above-described operator display control apparatus 101. An information processing apparatus (computer) described in claims corresponds to the above-described customer photographed-image display apparatus 102.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-240513 filed Oct. 19, 2009, which is hereby incorporated by reference herein in its entirety.

What is claimed is:

1. An information processing apparatus having a plurality of displays, the information processing apparatus comprising:
a reception unit configured to receive, from a display control apparatus, display image information about a plurality of images that are displayed on a display of the display control apparatus;
a determination unit configured to determine, based on the display image information received by the reception unit and configuration information about the plurality of displays, which of the plurality of displays is to display the plurality of images indicated by the display image information; and
a display unit configured to display the plurality of images on the plurality of displays based on a determination by the determination unit.

2. The information processing apparatus according to claim 1, wherein the image information includes information about a plurality of thumbnail images that are displayed on the display of the display control apparatus and information about a detailed display image selected from the plurality of thumbnail images, and
wherein the determination unit determines, based on the display image information received by the reception unit and the configuration information about the plurality of displays, which of the plurality of displays is to display the plurality of thumbnail images and which of the plurality of displays is to display the detailed display image.

3. A method for displaying an image that is executed by an information processing apparatus having a plurality of displays, the method comprising:
receiving, from a display control apparatus, display image information about a plurality of images that are displayed on a display of the display control apparatus;
determining, based on the display image information received and configuration information about the plurality of displays, which of the plurality of displays is to display the plurality of images indicated by the display image information; and
displaying the plurality of images on the plurality of displays based on a determination from determining which of the plurality of displays is to display the plurality of images.

4. A computer-readable medium having stored thereon, a program that causes a computer having a plurality of displays to function as:
a reception unit configured to receive, from a display control apparatus, display image information about a plurality of images that are displayed on a display of the display control apparatus;
a determination unit configured to determine, based on the display image information received by the reception unit and configuration information about the plurality of displays, which of the plurality of displays is to display the plurality of images indicated by the display image information; and
a display unit configured to display the plurality of images on the plurality of displays based on a determination by the determination unit.
